(19) United States
(12) Patent Application Publication
(10) Pub. No.: US 2023/0394532 A1
(43) Pub. Date: Dec. 7, 2023

(54) ON-LOCATION AD CREATION

(71) Applicant: Swaybrand, Chicago, IL (US)

(72) Inventors: Horace Flournoy, Chicago, IL (US); Israel Idonije, Chicago, IL (US)

(21) Appl. No.: 18/205,556

(22) Filed: Jun. 4, 2023

Related U.S. Application Data
(60) Provisional application No. 63/327,749, filed on Apr. 5, 2022.

(51) Int. Cl. G06Q 30/0241; G06Q 30/0273; H04N 21/80

(52) U.S. Cl. CPC G06Q 30/0276; G06Q 30/0273; G06Q 30/0277; H04N 21/80

(57) ABSTRACT

The present system allows the connection of Creators and Brands to make Creator generated promotional content. In one embodiment, a Brand will establish a campaign and define metrics for the type of Creator that is desired by the Brand. These metrics can include the number of followers, demographic information about the Creator and the followers, and the platform(s) of the Creator. In one embodiment, a Creator will discover promotional opportunities using a system app and request to be part of the promotional experience. The Brand can accept the request and provide a digital handshake to confirm terms and conditions between the Creator and the Brand. In another embodiment, geo-tracking is used to identify a Creator at the venue who satisfies the metrics. At that moment, the Creator is notified of an offer to create an instant promotion for the venue, with payment terms provided as part of the offer.

This patent application claims priority to U.S. Provisional Patent Application 63/327,749 filed on Apr. 5, 2022, which is incorporated by reference herein in its entirety.

### BACKGROUND OF THE SYSTEM

Celebrity endorsement is a technique for raising Brand and product awareness. Having a celebrity associated with a Brand or product can significantly increase sales. However, many celebrities are reluctant to openly endorse a particular Brand or product. For many years, celebrities have been willing to endorse products or Brands in other countries than their own (for example, many Hollywood celebrities have done commercials in Japan but not in the USA).

With the rise of social media, many celebrities have found ways to represent Brands without appearing to do so, by organically mentioning products in their social media posts, giving the impression that they are using a particular Brand or product. These mentions are paid endorsements, but do not appear to actually be commercials, allowing both the celebrity and Brand to profit. The social media mentions appear more as a “word-of-mouth” communication versus a paid advertisement.

Social media itself has created its own category of celebrities, often referred to as “influencers”. Influencers may sometimes have the reach and notoriety to attract the attention of national Brands for endorsement opportunities. Some influencers are more associated with local Brands, such as restaurants, hair salons, nightclubs, bars, and the like. Often an influencer will reach out to a Brand, product, venue, or the like to request compensation in some form in return for mentions and publicity on the influencer's platforms. The compensation can be as little as a comped meal all the way up to monetary compensation per each mention of a Brand.

A Creator is someone who creates content and presents it on the internet. A Creator may make YouTube or TikTok videos, Instagram posts, Facebook posts, or the like. A Creator often has a theme for their content, and creates many posts, videos, shorts, images, and the like on a regular basis to gain subscribers. In many cases, Creators hope to have enough of an audience to attract advertising, or to have paid subscribers. Creators are interested in having a paid relationship with Brands to be compensated for creating their content. A Creator may be a celebrity, athlete, singer, painter, photographer, author, actor, influencer, and the like.

A current disadvantage of the system of connecting Creators and Brands is a lack of mutual knowledge of each party. A Brand may not be fully aware of the reach, audience, demographics, geolocation, etc. of the followers of a Creator. In addition, the Creator may not know the metrics that a Brand is looking for without having extensive contact with Brand representatives. In some cases, it is a matter of timing where the Brand and the Creator connect by coincidence.

### SUMMARY

The present system allows the connection of Creators and Brands to make Creator-generated promotional content, with rates and conditions provided at the time of engagement, allowing both parties to determine if a useful relationship can be created. In one embodiment, a Brand can create a campaign and make it available through the system. This can be through an alert to Creators or by showing up on a map accessed by Creators.

In some cases, a fixed venue will desire to entice a Creator who happens to be present in the venue to create content about the venue. The venue will establish metrics for the type of Creator that is desired by the Brand. These metrics can include, number of followers, demographic information about the Creator and the followers, and the platform(s) of the Creator. In one embodiment, a Creator will discover promotional opportunities using a system app and request to be part of the promotional experience. The Brand can accept the request and provide a digital handshake to confirm terms and conditions between the Creator and the Brand. In another embodiment, geo-tracking is used to identify a Creator at the venue who satisfies the metrics. At that moment, the Creator is notified of an offer to create an available promotion for the venue or Brand, with payment terms provided as part of the offer.

### BRIEF DESCRIPTION OF THE DRAWINGS

FIG. 1 is a block diagram of an embodiment of the system.

FIG. 2 is a flow diagram of offering a Brand opportunity map in an embodiment of the system.

FIG. 3 is a flow diagram of producing content in an embodiment of the system.

FIG. 4 is a flow diagram illustrating user of content in an embodiment of the system.

FIG. 5 illustrates a map of offers in an embodiment of the system.

FIG. 6 illustrates a detailed view of an offer in an embodiment of the system.

FIG. 7 is a flow diagram of an alternate embodiment of the system.

FIG. 8 illustrates an embodiment of a Flow Wallet of the system.

FIG. 9 illustrates an embodiment of Brand Flow in an embodiment of the system.

FIG. 10 illustrates the use of AI for content creation in an embodiment of the system.

FIG. 11 illustrates models of neural networks and AI operations in an embodiment of the system.

FIG. 12 illustrates an example computer implementation of an embodiment of the system.

### DETAILED DESCRIPTION OF THE SYSTEM

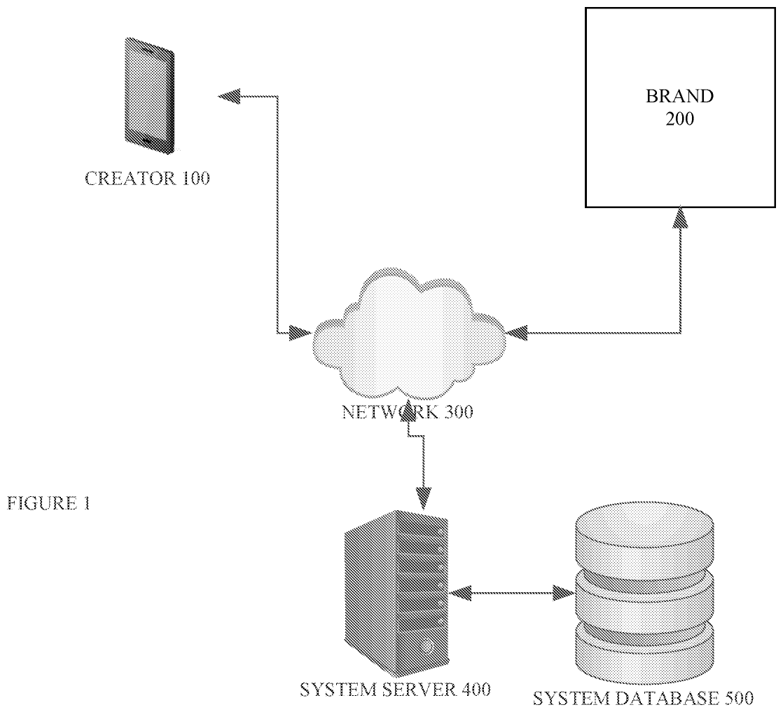

The system provides a way to connect Creators and Brands to create promotions for the Brand. FIG. 1 is a block diagram illustrating an embodiment of the system. A Creator 100 uses a smartphone to connect via network 300 to the System Server 400. Similarly, a Brand 200 connects to the System Server 400 via network 300. The System Server 400 is coupled to a System Database 500.

The System Server 400 registers Creators and Brands that are part of its system. In one embodiment, the system qualifies each Creator by requesting metrics to make sure the Creator meets some threshold metrics. Such metrics may include, but are not limited to, number of followers (e.g., at least 10,000 followers); hobbies, Q-rating, sport, career, interests, location, age, ethnicity, social media platform, and the like.

When a Creator registers with the system, the Creator can respond to prompts from the system to provide useful information that can be utilized by Brands. For example, the Creator may choose to indicate ethnicity, sexual orientation, country of origin or heritage, immigrant or native born, and the like. The Creator may also inform the system of what they are known for, such as comedy skits, short videos, pranks, reaction videos, critical reviews, unboxing, and the like. The Creator can identify “hustles and passions” such as preferred social media platform, music, sports, collector, investor, and the like. The Creator can also indicate the geographic locations where they create content. The Creator can submit, or give access to, their portfolio of media, posts, social media history, and the like, to improve the matching capability of the system. The Creator can also choose one or more images or avatars to represent the Creator.

The System Server 400 checks its Database 500 to see if the Brand has defined metrics for a campaign/promotion. If so, the System Server 400 populates a map that can be accessed by a Creator using a system application that shows locations of available promotion opportunities. One or more Creators can send a request to the system to participate in one or more of the available promotions.

In one embodiment, each request to participate in a campaign includes content including images, videos, and other content created by the Creator for the promotion. When a Creator submits a request to participate, even if they are not chosen, they are rewarded in some fashion (e.g., coupon, gift card, discount, digital badge, Brand items, and the like). This encourages participation and a greater amount of content from which the Brand can chose for its campaign.

If the Brand accepts the request, the System Server 400 sends a digital handshake to the Creator to confirm terms and conditions. Once the content is created, the System Server 400 updates its database 500 with the new information and pays the Creator an agreed upon initial submission fee for the content created by the Creator.

In one embodiment, the Brand may create a promotion in which some selected Creators are automatically allowed to submit content in a Request. The non-selected Creators can ask to submit a request and the Brand can evaluate each submission and determine if they will permit a Request. In one embodiment, the Brand may create a campaign that is open to all Creators or Creators who satisfy certain metrics. In this embodiment, the Brand may still allow Creators who don't satisfy those metrics to ask to participate and determine on a case by case basis to allow them to submit a Request. In one embodiment, the campaign may be open to all Creators, who each may submit a request to participate in the campaign.

A campaign may be location specific or general. In a location specific campaign, the Brand desires Creators to be at a specific location to create the content. This may be a location of the Brand (e.g., store, restaurant, dealership, and the like), or it may be a desired location that the Brand wants to be associated with, or has some meaning for the campaign. There are a number of so called “Instagram locations” where you may see many Creators making content. These spots have become known and attract Creators from all over the world to create content associated with the location. In some cases, a Brand may want to be associated with such a location. In other instances, the Brand may choose some event or other occasion that is occurring at a location, and invite Creators to that location.

Location Based Promotion

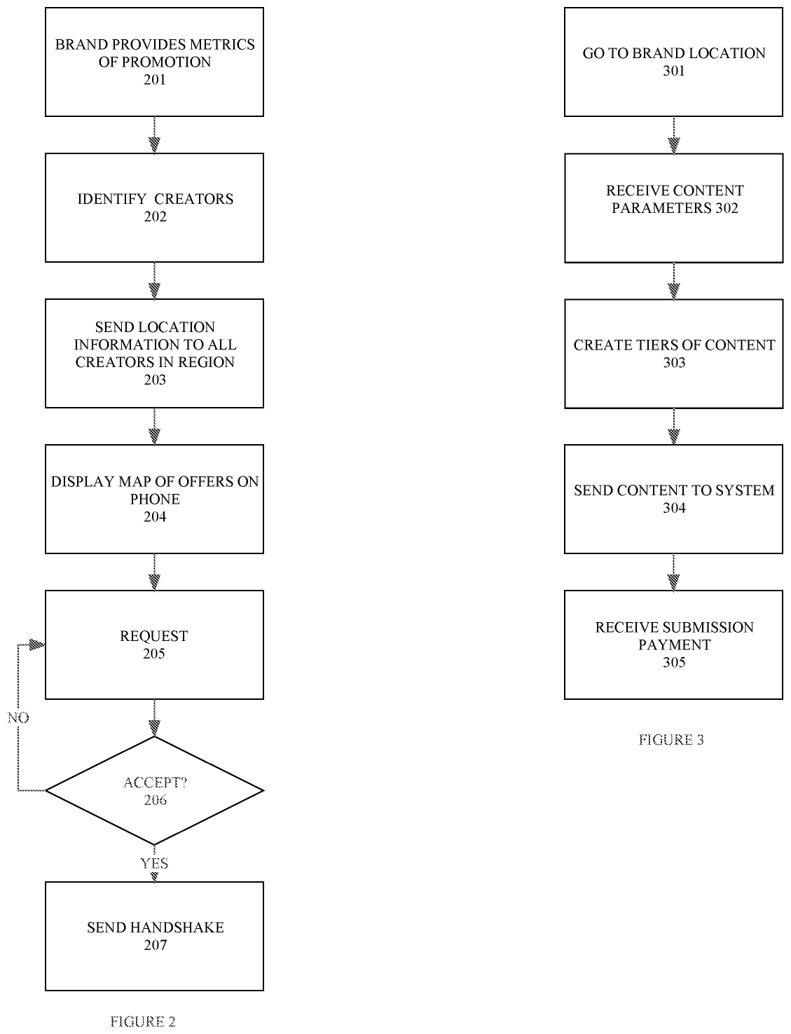

FIG. 2 is a flow diagram of a Brand offering a location based promotion in an embodiment of the system. At step 201 the Brand defines the campaign along with the location and the desired metrics that will define a qualified Creator and provides that to the system server 400 and system database 500. The Brand has access to all the profiles of registered Creators and can use search tools and filters to find desired Creators. The Brand can define a set of Creators as Qualified. This may be accomplished by using AI to select suitable Creators based on prompts provided by the Brand. A Qualified Creator can automatically submit content as part of a Request to participate in the promotion and the Brand will review the content to determine if the content will be part of the promotion.

An Unqualified Creator may still ask to participate in the promotion. Their content will not necessarily be reviewed. The Brand will decide on a case by case basis whether to permit an Unqualified Creator to submit a Request with content. In some cases, any Creator who is interested may submit a Request with content that will be reviewed by the Brand.

The location may include a defined range from the location from which to seek Creators (e.g., all Creators within 15 miles of the location). At step 202 the system identifies all Creators within the designated region.

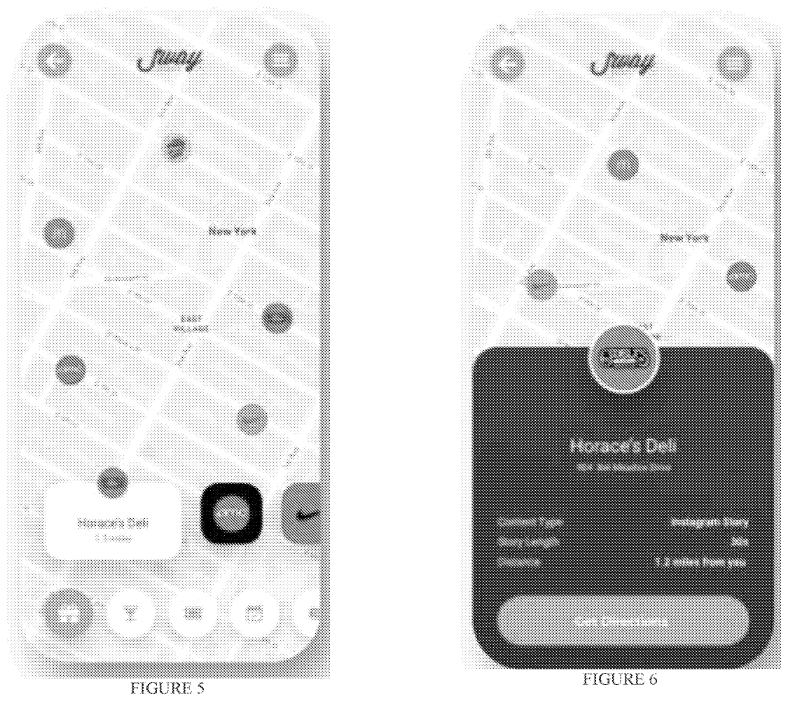

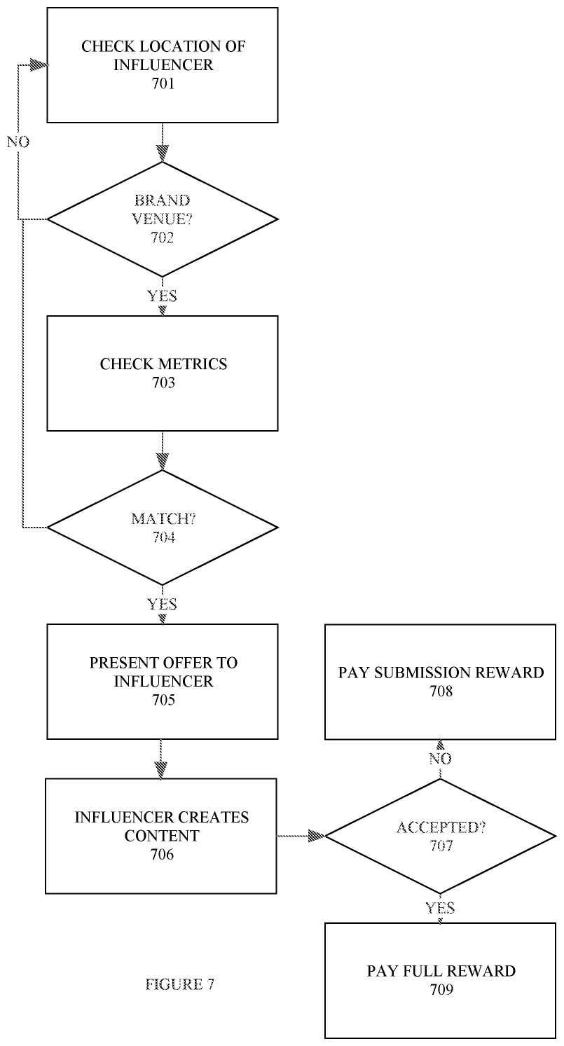

At step 203 the system adds the location to a map that tracks open offers and campaigns and sends location information of the campaign (and any others) to the smartphone of each Creator in the region. At step 204 the locations are shown on a map on the Creators' smartphone or other processing device. An example of the offer map is illustrated in FIG. 5 with each offer represented by an icon on the map. Each icon can be tapped to reveal more details about the offer, as shown in FIG. 6. In this example, the Creator has requested more information about an offer from a deli. The information includes the type of content desired (e.g., Instagram Story), the story length, and how close the location is. The Creator can also access payment information regarding the promotion, including up front payment, residuals for multiple use, sharing in advertising, and the like.

At step 205 a Creator who has interest in an offer goes to the location, creates the desired content, and sends a request through the system to participate in the promotion. At decision block 206 it is determined if the Creator is accepted to participate in the offer. If not, the system returns to step 205 and the Creator may send a request regarding another offer.

If the request is accepted at decision block 206, the system sends a digital handshake to the Creator at step 207. The digital handshake confirms the terms of participation in the offer and binds the participants to the terms. This may be implemented using blockchain technology and a smart contract defined by the Brand following parameters defined by the system.

Campaign

The Brand will use a system dashboard to build the campaign and define metrics. In one embodiment these metrics are defined in the categories of Campaign Overview, Compensation, Deliverables, Content Specs, Product Images, and MoodBoard.

The Campaign Overview includes the Campaign Title, Campaign Description, Start Date, End Date, and perhaps a geographic location. Compensation defines the type of compensation (e.g., cash, crypto, perks, affiliate status, free products, and the like). The deliverables description will define if it is to be text, images, and/or video, and include things the Creator should say or do when creating content, as well as things the Creator should avoid when creating content.

The Content Specs defines things such as the camera orientation (portrait or landscape) for images and videos, as well as one or more social media platforms of focus. The Product Images include images and/or video to be included in the content of the Creator as part of the promotion. The Moodboard can define if the content is to be comedic, serious, factual, flirty, fun, wild, and the like. The Moodboard can include backgrounds, audio tracks, soundtracks, and the like to be used with the content provided by the Creators.

The Campaign may, in an embodiment, define tiers of rewards that are available to consumers of the campaign. For example, there may be some number of high end rewards available in a limited quantity or to the first N purchases. Other rewards of decreasing value but increasing number may be offered as well.

Content Production

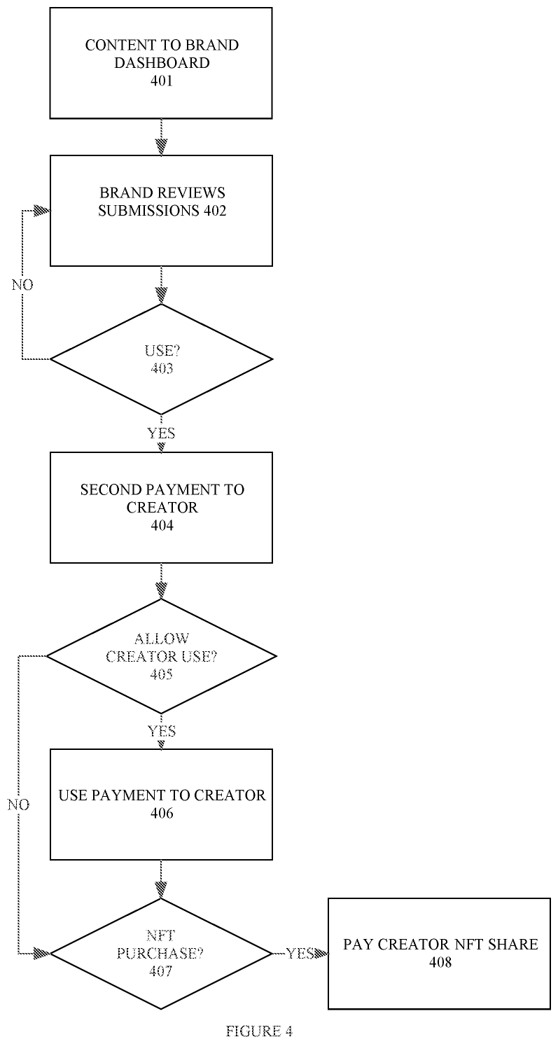

FIG. 3 is a flow diagram of producing content in an embodiment of the system in an embodiment that includes tiered rewards. At step 301 the Creator who wants to participate in an offered promotion goes to the Brand Location where the content is to be produced. At step 302 the Creator receives the parameters associated with the content to be created as noted above. The parameters still allow a Creator to use their own personality or behaviour to make the promotion fit their own style. In some cases, the parameters will request a particular product to be used or consumed, and certain words and/or phrases to be used by the Creator. As noted above, the parameters will also indicate the type of content to be created, e.g., Instagram story, your tube video, TikTok video, tweet, Facebook post, and the like. These parameters are typically included in the promotion offer.

In this embodiment, the system is used to create tiered content combined with an offer made via NFT for Web 3 enabled blockchain technology. The tiered content can provide offers of escalating value and escalating price that can be purchased by consumers of the created content. For example, in one embodiment, three tiers of content are created for a gym. In the first tier, the Creator creates content that informs users and followers of a giveaway, coupon, NFT, trial membership and the like that can be obtained if the user or follower comes to the gym and presents a code or some other indicia indicated in the first tier of content.

In a second tier, a more exclusive and/or limited NFT is offered, that may include training sessions, extended length of membership, access to reserved areas, and the like, for a higher fee.

A third tier can be even more exclusive, higher priced, and offer one of a kind experiences, such as training with the Creator, one-on-one sessions, appearance in future content or some other desirable or exclusive opportunity.

At step 303 the Creator creates the tiers of content. At step 304 the Creator sends the created content to the System. At step 305 the Creator receives the agreed upon submission payment. The submission payment is a reward to the Creator for submitting the content as part of the request to participate. It does not necessarily mean that the content will be used in the campaign. To encourage the production of sufficient content, the Brand will offer some reward simply for producing the content.

Submitted Content

FIG. 4 is a flow diagram of the review of submitted content by the Brand after receiving the Creator created content. (Note that at this point, an initial reward may have already been provided to the Creator just for submitting the content). At step 401 the created content is sent to a Brand dashboard in the system. The Brand can review all of the submitted content at step 402. At decision block 403 it is determined if submitted content will be used by the Brand. If not, the system returns to review at step 402.

If content is to be used at step 402, the content Creator gets a second payment at step 404, pursuant to the digital handshake (smart contract). The Brand can then post the content to its own sites, ads, promotions, and the like, pursuant to the agreement with the Creator.

In one embodiment, the Brand might allow the Creator to use the submitted content as well, under certain conditions. At decision block 405 it is determined whether to allow the Creator to post the content on the Creator's sites. This can be done to help increase awareness of the created content, but is not mandatory. If the Creator is permitted to post content on the Creator's sites and does so, the Creator may be given a use payment by the Brand at step 406.

After step 406, or if the Creator does not get to use the content at step 405, the system proceeds to decision block 407 to determine if any conversions have taken place as a result of the Creator content. In the case of tiered content, the Brand determines if any of the tiers of NFT's have been purchased. The Creator content includes a link for conversions and purchases, so such transactions can be easily tracked by the system. If so, the Creator is paid a share of the NFT income pursuant to the digital handshake agreement at step 408.

Geolocation Promotion

In one embodiment, a venue may have a standing promotion offer at one or more of its venues in case a Creator happens to be at the venue. This may be presented on the map as an active opportunity, to draw Creators to the location. In one embodiment, it is a passive offer that is triggered when a Creator is detected on the premises. This detection is via geolocation. The system tracks the location of Creators using their phones. If the system identifies a Creator at a location with a passive (or active) offer, the system will ping the user to alert the user to the opportunity.

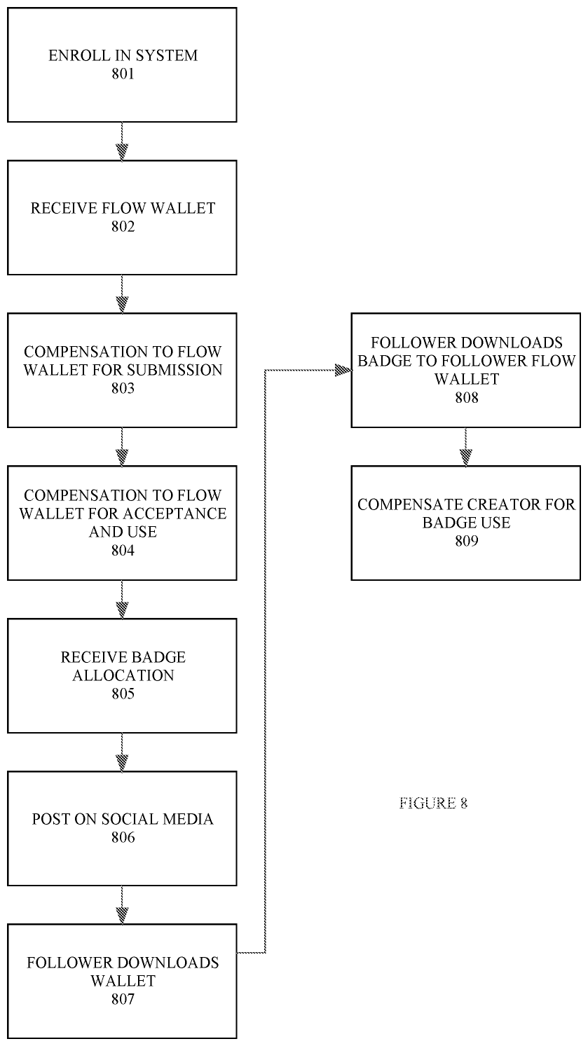

FIG. 7 is a flow diagram of an alternate embodiment offering a Brand opportunity based on geolocation. At step 701 the system uses geolocation to determine if an enrolled Creator 100 is in the same location as a designated Brand venue. The Creator makes their statistics and metrics available to the system. In one embodiment, the Creator can define desired promotional opportunities that the Creator would be interested in accepting. The Creator may also define a filter to screen out unwanted promotional opportunities. The filter may define unwanted products, Brands, geographical areas, and the like. In some cases, a Creator may have existing arrangements with certain Brands and/or products that preclude promoting competing Brands or products.

At decision block 702 it is determined if a system Creator is in a designated Brand venue. A designated Brand venue is a location where a Brand 200 desires for promotional content to be created. For example, a restaurant Brand may define its restaurant location as a Brand venue. An apparel Brand may designate one or more locations that reflect or enhance the image of its apparel. There are many so-called “Instagram spots” where users desire to take pictures and post to their various platforms. The apparel Brand may want to have their clothing associated with one or more of the Instagram Spots.

If there is no system Creator in the Brand venue the system returns to step 701. If there is a Creator at the Brand venue the system checks the metrics of the Creator at step 703. The Brand may have defined the reach and audience levels of a desired Creator that should be present before giving a promotion offer to the Creator. Other metrics may be set in addition to the number of followers, including demographics of the followers, demographic of the Creator, subject matter associated with the Creator, suitability for the Brand, and the like.

At decision block 704 it is determined if there is a match of the metrics of the Brand and the Creator. If not, the system returns to step 701. If so, the system proceeds to step 705 and presents an offer to the Creator. The offer, in an embodiment, is to make an ad or promotion while the Creator is at the Brand venue. For example, if the Brand venue is a restaurant, the offer may be to make a promotion about the restaurant and/or one or more dishes on the menu of the restaurant. Typically, the offer is presented by sending an alert to the Creator's smartphone. The system includes an app used by the Creator and the Brand and facilitates all the administration related to the transactions between the Creator and the Brand.

The Brand offers a fee to the Creator in return for submitting content for the promotion and a different fee if the content is used. In one embodiment, the fee may be on a sliding scale based on the popularity and reach of the Creator.

At step 706 the Creator creates the requested content and submits it to the Brand. At step 707 it is determined if the content is accepted for use. If not, the Brand pays the Creator the fee for submitting the content at step 708. If the content is accepted at step 707, the Brand pays the second fee to the Creator at step 709.

The system contemplates use by Creators, Brands, and agents or managers of Creators. Each entity can have a dashboard presence in the system to track offers, content, metrics, payments, and the like.

In one embodiment, Creator generated content is tracked and managed using a management system, for example, Content Authenticity Initiative. The system not only track use of the submitted content, but can also track modifications and derivative use of the content by others, even if manipulated by Artificial Intelligence (AI). Other content tracking and management schemes, including blockchain based schemes, can be used without departing from the scope and spirit of the system.

Creator Wallet

In one embodiment, the system provides each Creator with a digital wallet to improve the operation of the system. When a Creator signs up with the system at step 801 of FIG. 8, the Creator is given a custom wallet at step 802, referred to herein as a “Flow Wallet” that includes an account with the system or with a third party entity. When a Creator generates content, compensation for creating content can be directed immediately to the Flow Wallet at step 803. If the content is accepted for use, the system provides monetary compensation for transfer directly to the Flow Wallet at step 804.

In one embodiment, the Creator may also receive a Brand Badge allocation at step 805 for having content accepted by the Brand. The Badge encourages the Creator to post about the Brand on social media. When the Creator posts about the Brand on social media at step 806, it includes an opportunity for followers to download their own version of the Flow Wallet at step 807.

In one embodiment, there are a limited number of Badges available. Each Badge, when used with the Flow Wallet in a transaction with the Brand, offers some reward, such as a discount, unique offer, and the like. At step 808 a follower downloads the Badge, which becomes associated the followers Flow Wallet and can be used for transactions with the Brand. At step 809, the Creator is compensated for each transaction using a Badge that originated with the Creator.

Brand Flow

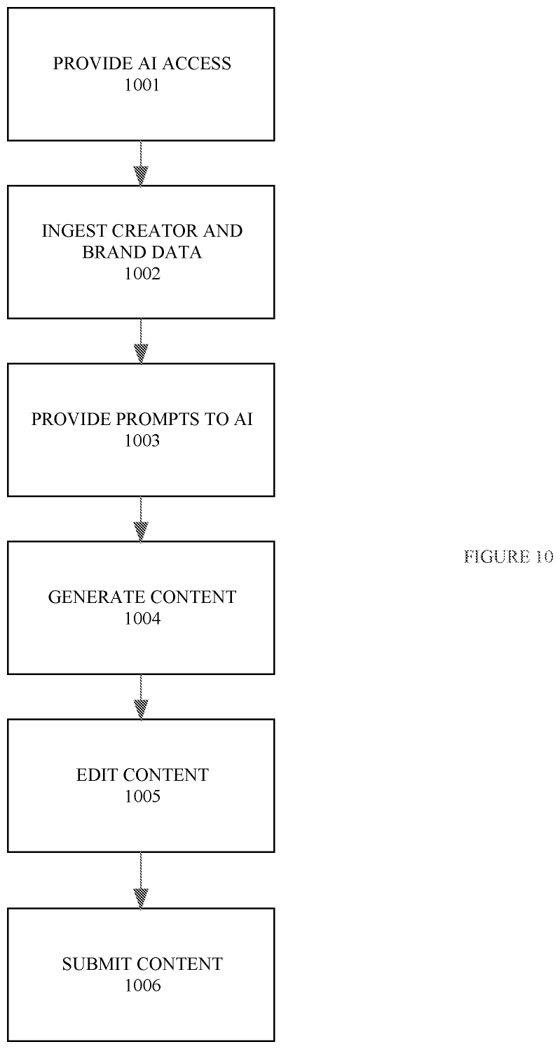

FIG. 9 illustrates Brand Flow in an embodiment of the system. At step 901 a Brand enrolls in the system and creates an account. At step 902 the System provides a process to create a Brand Wallet. This may be a wallet implemented using blockchain technology to reduce risk and to validate transactions.

At step 903 the Brand creates a campaign for a product or service. This comprises defining the style (images, text, video, etc.) of the campaign, the delivery type (e.g., Instagram, FaceBook, TikTok, and the like), defining the metrics of the type of Creator that is acceptable to the Brand for the campaign (e.g., number of followers, specialty, ethnicity, gender, and the like), the rewards for submission and for acceptance, and the like.

At step 904 the Brand creates a Badge or Badges to be associated with the campaign. The Badge will be defined as a discount, free item, money off, right to by a limited edition item, and the like. The Brand can then use the system to offer the campaign to Creators.

At step 905 the Brand approves one or more Creators for use of their content. At step 906 the Brand transfers Badges to the accepted Creators. At step 907 the Brand honors the Badges when used in transactions.

AI Generated Content

FIG. 10 illustrates the generation of content using AI implemented by the system. At step 1001 the system provides access to a machine learning/AI system for use by a Creator. At step 1002 the system ingests the social media history of the Creator as well as Brand information.

At step 1003 the Creator invokes the AI and defines prompts to the AI to produce content for the Brand in the style and voice of the Creator. At step 1004 the AI generates content based on the prompts. The content could be any combination of text, images, and video. The content could be a script for the Creator to use to generate a video.

At step 1005 the Creator reviews the content and edits as appropriate and then creates the content. At step 1006 the Creator submits the content to the Brand for possible use.

AI Models

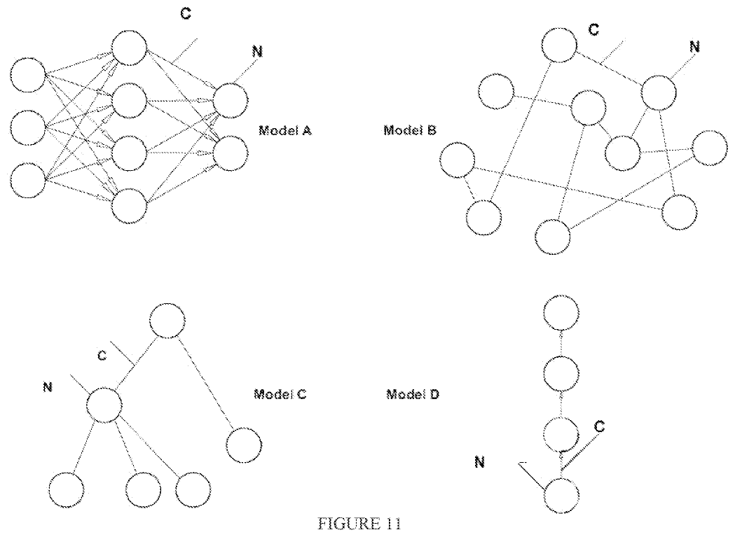

Referring to FIG. 11, the teaching presented by the disclosure can be implemented to include various artificial intelligence models (“AIMs”) and/or techniques. The disclosed devices, systems, and methods for learning and using AIMs are independent of the artificial intelligence model and/or technique used and any model and/or technique can be utilized to facilitate the functionalities described herein. Examples of these models and/or techniques include deep learning, supervised learning, unsupervised learning, neural networks (i.e., convolutional neural network, recurrent neural network, deep neural network, etc.), search-based, logic and/or fuzzy logic-based, optimization-based, tree/graph/other data structure-based, hierarchical, symbolic and/or sub-symbolic, evolutionary, genetic, multi-agent, deterministic, probabilistic, statistical, and/or other models and/or techniques.

In one example shown in Model A, the disclosed devices, systems, and methods for learning and using AIMs may include a neural network (also referred to as artificial neural network, etc.). As such, machine learning, knowledge representation or structure, pattern recognition, decision making, and/or other artificial intelligence functionalities may include a network of Nodes N (also referred to as neurons in the context of neural networks, etc.) and Connections C similar to that of a brain. Node N can store any data, object, data structure, and/or other item, or reference thereto. Node N may also include a function for transforming or manipulating any data, object, data structure, and/or other item. Examples of such transformation functions include mathematical functions (i.e. addition, subtraction, multiplication, division, sin, cos, log, derivative, integral, etc.), object manipulation functions (i.e. creating an object, modifying an object, deleting an object, appending objects, etc.), data structure manipulation functions (i.e. creating a data structure, modifying a data structure, deleting a data structure, creating a data field, modifying a data field, deleting a data field, etc.), and/or other transformation functions. Connection C can store or be associated with a value such as a symbolic label or numeric attribute (i.e., weight, cost, capacity, length, etc.). A neural network can be utilized as a predictive modelling approach in machine learning. A computational model can be utilized to compute values from inputs based on a pre-programmed or learned function or method. For example, a neural network may include one or more input neurons that can be activated by inputs. Activations of these neurons can then be passed on, weighted, and transformed by a function to other neurons. Neural networks may range from those with only one layer of single direction logic to multi-layer of multi-directional feedback loops. A neural network can use weights to change the parameters of the network's throughput. A neural network can learn by input from its environment or from self-teaching using written-in rules.

In another example shown in Model B, the disclosed devices, systems, and methods for learning and using AIMS may include a graph or graph-like data structure. As such, machine learning, knowledge representation or structure, pattern recognition, decision making, and/or other artificial intelligence functionalities may include Nodes N (i.e., vertices, points, etc.) and Connections C (i.e., edges, arrows, lines, arcs, etc.) organized as a graph. A graph can be utilized as a predictive modelling approach in machine learning. In general, any Node N in a graph can be connected to any other Node N. A Connection C may include unordered pair of Nodes N in an undirected graph or ordered pair of Nodes N in a directed graph. Nodes N can be part of the graph structure or external entities represented by indices or references. Nodes N, Connections C, and/or operations of a graph may include any features, functionalities, and embodiments of the aforementioned Nodes N, Connections C, and/or operations of a neural network, and vice versa.

In a further example shown in Model C, the disclosed devices, systems, and methods for learning and using AIMs may include a tree or tree-like structure. As such, machine learning, knowledge representation or structure, pattern recognition, decision making, and/or other artificial intelligence functionalities may include Nodes N and Connections C (i.e., references, edges, etc.) organized as a tree. A tree can be utilized as a predictive modelling approach in machine learning. In general, a Node N in a tree can be connected to any number (i.e., including zero, etc.) of children Nodes N (i.e., similar to a tree, etc.). In some aspects, a collection of trees can be utilized where each tree may represent a set of related conversational paths such as, for example, paths concerning a topic or concept. Nodes N, Connections C, and/or operations of a tree may include any features, functionalities, and embodiments of the aforementioned Nodes N, Connections C, and/or operations of a neural network and/or graph, and vice versa.

In a further example shown in Model D, the disclosed devices, systems, and methods for learning and using AIMs may include a sequence or sequence-like structure. As such, machine learning, knowledge representation or structure, pattern recognition, decision making, and/or other artificial intelligence functionalities may include a structure of Nodes N and Connections C organized as a sequence.

In some aspects, Connections C may be optionally omitted from a sequence. A sequence can be utilized as a predictive modelling approach in machine learning. In some aspects, a sequence can be used to store a single data point. In other aspects, a sequence can be used to store multiple concatenated data points. Nodes N, Connections C, and/or operations of a sequence may include any features, functionalities, and embodiments of the aforementioned Nodes N, Connections C, and/or operations of a neural network, graph, and/or tree, and vice versa.

In yet another example the disclosed devices, systems, and methods for learning and using AIMS may include a search-based model and/or technique. As such, machine learning, knowledge representation or structure, pattern recognition, decision making, and/or other artificial intelligence functionalities may include searching through a collection of possible solutions. For example, a search method can search through a neural network, graph, tree, list, or other data structure that includes data elements of interest. A search may use heuristics to limit the search for solutions by eliminating choices that are unlikely to lead to the goal. Heuristic techniques may provide a best guess solution. A search can also include optimization. For example, a search may begin with a guess and then refine the guess incrementally until no more refinements can be made. In a further example, the disclosed devices, systems, and methods for learning and using AIMS may include logic-based model and/or technique. As such, machine learning, knowledge representation or structure, pattern recognition, decision making, and/or other artificial intelligence functionalities can use formal or other type of logic. Logic based models may involve making inferences or deriving conclusions from a set of premises. As such, a logic based system can extend existing knowledge or create new knowledge automatically using inferences. Examples of the types of logic that can be utilized include propositional or sentential logic that comprises logic of statements which can be true or false; first-order logic that allows the use of quantifiers and predicates and that can express facts about objects, their properties, and their relations with each other; fuzzy logic that allows degrees of truth to be represented as a value between 0 and 1 rather than simply 0 (false) or 1 (true), which can be used for uncertain reasoning; subjective logic that comprises a type of probabilistic logic that may take uncertainty and belief into account, which can be suitable for modelling and analyzing situations involving uncertainty, incomplete knowledge and different world views; and/or other types of logic

In a further example the disclosed devices, systems, and methods for learning and using AIMs may include a probabilistic model and/or technique. As such, machine learning, knowledge representation or structure, pattern recognition, decision making, and/or other artificial intelligence functionalities can be implemented to operate with incomplete or uncertain information where probabilities may affect outcomes. A Bayesian network, among other models, is an example of a probabilistic tool used for purposes such as reasoning, learning, planning, perception, and/or others. One of ordinary skill in art will understand that the aforementioned artificial intelligence models and/or techniques are described merely as examples of a variety of possible implementations, and that while all possible artificial intelligence models and/or techniques are too voluminous to describe, other artificial intelligence models and/or techniques known in art are within the scope of this disclosure. One of ordinary skill in art will also recognize that an intelligent system may solve a specific problem by using any model and/or technique that works such as, for example, some systems can be symbolic and logical, some can be sub-symbolic neural networks, some can be deterministic or probabilistic, some can be hierarchical, some may include searching techniques, some may include optimization techniques, while others may use other or a combination of models and/or techniques. In general, any artificial intelligence model and/or technique can be utilized that can support AIM functionalities.

Example Computer Implementation

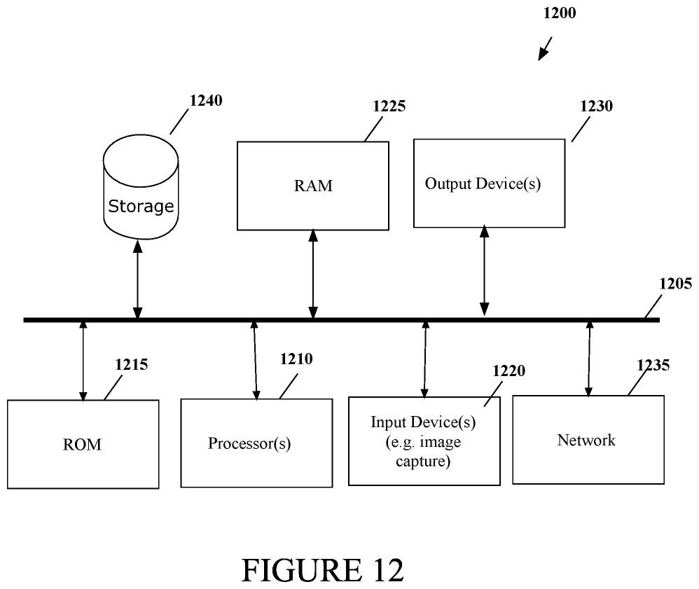

FIG. 12 illustrates an exemplary a system 1200 that may implement the system. The electronic system 1200 of some embodiments may be a mobile apparatus. The electronic system includes various types of machine readable media and interfaces. The electronic system includes a bus 1205, processor(s) 1210, read only memory (ROM) 1215, input device(s) 1220, random access memory (RAM) 1225, output device(s) 1230, a network component 1235, and a permanent storage device 1240.

The bus 1205 communicatively connects the internal devices and/or components of the electronic system. For instance, the bus 1205 communicatively connects the processor(s) 1210 with the ROM 1215, the RAM 1225, and the permanent storage 1240. The processor(s) 1210 retrieve instructions from the memory units to execute processes of the invention.

The processor(s) 1210 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine readable storage medium (also referred to as machine readable medium). When these instructions are executed by one or more of the processor(s) 1210, they cause the processor(s) 1210 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 1210. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 1200, define one or more specific machine implementations that execute and perform the operations of the software programs.

The ROM 1215 stores static instructions needed by the processor(s) 1210 and other components of the electronic system. The ROM may store the instructions necessary for the processor(s) 1210 to execute the processes provided by the system. The permanent storage 1240 is a non-volatile memory that stores instructions and data when the electronic system 1200 is on or off. The permanent storage 1240 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 1225 is a volatile read/write memory. The RAM 1225 stores instructions needed by the processor(s) 1210 at runtime, the RAM 1225 may also store the real-time video or still images acquired by the system. The bus 1205 also connects input and output devices 1220 and 1230. The input devices enable the user to communicate information and select commands to the electronic system. The input devices 1220 may be a keypad, image capture apparatus, or a touch screen display capable of receiving touch interactions. The output device(s) 1230 display images generated by the electronic system. The output devices may include printers or display devices such as monitors.

The bus 1205 also couples the electronic system to a network 1235. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus, an ad-creation system has been described.

What is claimed is:

1. A method of creating content comprising:
using a processing system to define a promotion for a Brand and to inform a plurality of Creators of the promotion;
receiving a Request from one or more of the plurality of Creators that includes content related to the promotion;
the Brand providing a first level of compensation to each Creator that submits a Request;
the Brand reviewing each Request and identifying one or more Requests for use in the promotion;
the Brand providing a second level of compensation to each Creator whose Request is used in the promotion.

2. The method of claim 1 wherein the promotion defines a plurality of metrics.

3. The method of claim 2 wherein the metrics comprise Campaign Overview, Compensation, Deliverables, Content Specs, Product Images, and MoodBoard.

4. The method of claim 3 wherein the deliverables comprise one or more of images, video, audio, and text.

5. The method of claim 4 wherein the deliverables further include defining a social media platform for presenting content related to the promotion.

6. The method of claim 1 further including providing a digital wallet to each Creator.

7. The method of claim 6 further including adding a badge to the digital wallet of each Creator whose Request is used in the promotion.

8. The method of claim 7 wherein a consumer can download the badge and use it in a transaction.

9. The method of claim 8 wherein the Brand compensates a Creator when a badge of the Creator is used by a consumer.

10. The method of claim 1 wherein the Brand informs Creators of a promotion by populating a digital map with a location of the promotion.
